(19) United States
(12) Patent Application Publication
(10) Pub. No.: US 2003/0046526 A1
(43) Pub. Date: Mar. 6, 2003

(54) Multilingual system and method for displaying data on a user interface

(75) Inventors: Jiessie Zhang, Chongging (CN); Simon Qin, Chongging (CN)

Correspondence Address: HOGAN & HARTSON L.L.P., 500 S. GRAND AVENUE, SUITE 1900, LOS ANGELES, CA, 90071-2611, US

(73) Assignee: FarStone Technology Inc.

(21) Appl. No.: 10/116,281

(22) Filed: Apr. 4, 2002

(30) Foreign Application Priority Data
Sep. 3, 2001 (TW) 90121811

(51) Int. Cl. G06F 15/177; G06F 9/24; G06F 9/00

(52) U.S. Cl. 713/1

(57) ABSTRACT

A multilingual system and methodology that displays data on a user interface for a computer system. According to the invention, the multilingual system and method is suitable for a computer system, having a detecting apparatus and the user interface configured therein. The detecting apparatus includes a BIOS and an operating system (OS). The BIOS performs functions of the computer system. The operating system (OS) controls the computer system. The user interface provides options for a user and displays a language met with the user's demand. The method comprising the steps of: (a) deciding the predetermined data that can be displayed on the user interface for the user; (b) performing a predetermined process to convert the predetermined data into a corresponding data, the predetermined data can be displayed on the user interface of the computer system; and (c) storing the corresponding data in a storage apparatus to hold the corresponding data therein, the corresponding data can be retrieved by the computer system. By utilizing the present method to display multilingual data on the user interface for supporting a ROM program, the user interface with support for one or more of a plurality of multi-byte character languages is more friendly and smoothly to the users.

### BACKGROUND OF THE INVENTION

1. Field of the Invention

The present invention relates generally to a multilingual technique for a computer system, and more particularly to a multilingual system and method that supports multi-byte character languages, such as Chinese or Japanese, etc., for programs stored in a read only memory (ROM) of the computer system.

2. Description of Prior Art

Generally, a user of a computer system prefers a User Interface (UI) of the computer system to display a language that is familiar to him/her so that he/she can operate the computer system more easily when he/she is performing application programs using the computer system. Such need is particularly important to many Asian people whose first languages are not English.

There are two conventional ways that can support multi-language for the UI. One such way is that a user may select his/her preferred operating language by himself/herself. Another such way is that the language is automatically determined through language codes provided by the operating system, such as Microsoft's Window 2000, of the computer system for its application programs. For example, Microsoft's Outlook Express provides the user with multi-language support.

However, the conventional techniques do not support multi-language for application programs, such as a BIOS program, an anti-virus program, or a backup/recovery program, that are burnt onto a ROM. As a result, all the conventional programs stored in a ROM are supported by English only. And no language other than English can be displayed on the UI for the ROM programs.

The Asian languages, such as Chinese or Japanese, typically belong to multi-byte character languages, as compared to most of the Western languages, such as English, that belong to uni-byte character languages. Moreover, most Western languages, such as English, are constituted by a limited number of letters, e.g., 26 letters. In contrast, many Asian languages have a large number of characters. For instance, the Chinese language is constituted by more than 6000 Chinese characters.

The characters of most Asian languages, such as Chinese, are typically shown in the computer as dot-matrix characters. For a dot-matrix character, a character font pattern is displayed on a screen of a computer system. The computer system processes a multiplicity of pixel data that together form a character. For instance, a 16*16 dot-matrix Chinese character is displayed as a matrix of sixteen columns of pixels by sixteen rows of pixels to display, and every pixel data represents whether to be displayed with a bit.

The character font data is needed for a display apparatus to display a Chinese character. The character font data provides 256 bits (32 bytes) respectively for each Chinese character. Accordingly, a total of more than 6000 Chinese characters need storage space amounted to 192 kilobytes (kb). When other related data is to be included, a grand total of the amount of storage space needed will be about 240 kb for the character font data to display all Chinese characters and symbols.

The ROM space of the computer system is 256 kb merely. However, the character font data for all Chinese characters and symbols occupy about 240 kb, most of ROM space. Consequently, conventional program burned onto a ROM would be almost impossible to support multi-language owing to a huge amount of storage space on the Chinese characters and symbols.

In contrast, the western languages, English especially, are mostly constituted by uni-byte characters. Each English character occupies 16 bytes, and the storage space needed for English characters totals to only 416 bytes (26*16 bytes). As a result, due the limited space available in the ROM, only English interface can be used in presently available application programs stored in the ROM.

On the other hand, although Microsoft's Outlook Express can support multi-language through Window operating systems, such technique has limited application. It provides the ROM programs with no support of multi-language display on the user interface.

### SUMMARY OF THE INVENTION

The present invention provides a multilingual system and method to resolve the foregoing problems faced by the conventional ROM programs. The present invention also has the advantage of providing ROM programs with Asian languages, such as Chinese or Japanese, etc., without the need of a large amount of storage space occupied in the ROM. Moreover, the multilingual system and method is convenient to manufacture and operate.

An object of the present invention is to provide a multilingual system and method for displaying data on a user interface, wherein the ROM programs can be operated by the user more easily. It makes the user interface more friendly and smoothly to the users.

Another object of the present invention is to provide a multilingual system and method for displaying data on a user interface, which is suitable for supporting single multi-byte-character Asian language, such as Chinese or Japanese, etc., in the ROM for display.

A further object of the present invention is to provide a multilingual system and method for displaying data on a user interface, which can support each language in the world. Moreover, according to the present invention, the cost can be reduced, and the operation can be simplified.

In accordance with an aspect of the present invention, a multilingual system is installed in a computer system. The computer system has a detecting apparatus and the user interface configured therein. The BIOS processes predetermined functions of the computer system. The operating system (OS) controls operations of the computer system. The user interface provides selectable options for a user. The multilingual system comprises a database for holding a predetermined data, the predetermined data corresponded to one or more of a plurality of languages being displayed on the user interface; and a storage apparatus for storing the database that supports a ROM program for displaying the language on the user interface.

In the preferred embodiment of the invention, the ROM program includes a program burned onto a ROM. The ROM program may include a BIOS program, an anti-virus program, or a backup/recovery program. The language includes a multi-byte character language, which includes a Unicode character. The language can be any language in the world. The predetermined data includes a compressed data. The predetermined data may be recorded the status for each pixel of characters of the language. The storage apparatus is a ROM. The language can be switched by the user, selected through the user interface by the user or decided by a program stored in the BIOS or the BIOS determining a language version of an Operating System (OS) of the computer system. The language can be selected automatically by the BIOS in accordance with a language version of an Operating System (OS) in an active partition of a hard disk drive (HDD) of the computer system. The language can be decided by an Operating System (OS) of the computer system by detecting a language version of the BIOS. The language can be selected by an Operating System (OS) of the computer system in accordance with a program stored in the BIOS.

In accordance with another aspect of the present invention, a method for displaying multilingual data on a user interface is suitable for a computer system. The computer system has a detecting apparatus and the user interface configured therein. The detecting apparatus includes a BIOS and an operating system (OS). The BIOS processes predetermined functions of the computer system. The operating system (OS) controls operations of the computer system. The user interface provides selectable options for a user. The method comprises the steps of: detecting the computer system to determine a language used in the computer system; retrieving a first data of the determined language kept in the computer system to display the determined language on the user interface in accordance with the determined language used in the computer system; and displaying a second data corresponded to the first data on the user interface to support a ROM program.

In the preferred embodiment of the invention, the BIOS determines a language version of the OS when the OS is searched and initialized after power-ON for the computer system. The ROM program includes a program burned onto a read only memory (ROM). The ROM program may include a BIOS program, an anti-virus program, or a backup/recovery program. The language includes a multi-byte character language, which includes a Unicode character. The language can be any language in the world. The predetermined data includes a compressed data. The predetermined data may be recorded the status for each pixel of characters of the language. The storage apparatus is a read only memory (ROM). The language can be switched by the user, selected through the user interface by the user or decided by a program stored in the BIOS or the BIOS determining a language version of an Operating System (OS) of the computer system. The language can be selected automatically by the BIOS in accordance with a language version of an Operating System (OS) in an active partition of a hard disk drive (HDD) of the computer system. The language can be decided by an Operating System (OS) of the computer system by detecting a language version of the BIOS. The language can be selected by an Operating System (OS) of the computer system in accordance with a program stored in the BIOS. The language can be decided by the Operating System (OS) of the computer system by detecting a language version of the BIOS. The method further comprises the step of selecting the language automatically by the BIOS in accordance with a language version of the Operating System (OS) in an active partition of a hard disk drive (HDD) of the computer system. The method further comprises the step of selecting the language by the Operating System (OS) of the computer system in accordance with a program stored in the BIOS.

In accordance with a further aspect of the present invention, another method for displaying multilingual data on a user interface is suitable for a computer system. The computer system has a detecting apparatus and the user interface configured therein. The detecting apparatus includes a BIOS and an operating system (OS). The BIOS processes functions of the computer system. The operating system (OS) controls the computer system. The user interface provides options for a user. The method comprises the steps of: deciding a first data that can be displayed on the user interface for the user; and storing a second data in a storage apparatus to hold the second data corresponded to the first data therein, the second data can be retrieved by the computer system, in order to display the first data on the user interface for supporting a ROM program.

In the preferred embodiment of the invention, the method further comprises the step of performing a predetermined process to convert the first data into a second data. The ROM program includes a program burned onto a read only memory (ROM). The ROM program may include a BIOS program, an anti-virus program, or a backup/recovery program. The language includes a multi-byte character language, which includes a Unicode character. The language can be each language in the world. The second data includes a compressed data. The second data may be recorded the status for each pixel of characters of the language. The storage apparatus is a read only memory (ROM). The language can be switched by the user, selected through the user interface by the user or decided by a program stored in the BIOS or the BIOS determining a language version of an Operating System (OS) of the computer system. The language can be selected automatically by the BIOS in accordance with a language version of an Operating System (OS) in an active partition of a hard disk drive (HDD) of the computer system. The language can be decided by an Operating System (OS) of the computer system detecting a language version of the BIOS. The language can be selected by an Operating System (OS) of the computer system in accordance with a program stored in the BIOS.

The present invention may best be understood through the following description with reference to the accompanying drawings, in which:

### BRIEF DESCRIPTION OF THE DRAWING

FIG. 1 shows a schematic block diagram of a multilingual system of a preferred embodiment according to the present invention.

FIG. 2 shows a schematic flow chart of a multilingual method of the preferred embodiment according to the present invention.

FIG. 3 shows another schematic flow chart of a multilingual method of the preferred embodiment according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purpose of illustration and description only. It is not intended to be exhaustive or to be limited to the precise form disclosed.

The present invention describes a new multilingual technique for a ROM program to display at least one language on the UI, which can contain Chinese or Japanese or other multi-byte character languages. The amount of data occupied in the storage space within the ROM is small, so that the storage space can be economized. Thus, it would be available for provide a program burned onto a ROM with multilingual support.

With the multilingual technique of the present invention, the single or multiple languages can be used in a ROM program. The language can be switched by the user, selected through the user interface by the user or decided by a program stored in the BIOS or the BIOS determining a language version of an Operating System (OS) of the computer system. The language can be selected automatically by the BIOS in accordance with a language version of an Operating System (OS) in an active partition of a hard disk drive (HDD) of the computer system. The language can be decided by an Operating System (OS) of the computer system detecting a language version of the BIOS. The language can be selected by an Operating System (OS) of the computer system in accordance with a program stored in the BIOS. Therefore, the drawbacks faced by the prior arts can be solved completely.

According to the preferred embodiment of the present invention, a multilingual system is installed in a computer system. The computer system has a BIOS and the user interface configured therein. The BIOS processes functions of the computer system. The user interface provides options for a user. The multilingual system comprises a database for holding a predetermined data, the predetermined data corresponded to one or more of a plurality of languages being displayed on the user interface; and a storage apparatus for storing the database that supports a ROM program for displaying the language on the user interface.

The ROM program includes a program burned onto a ROM. The ROM program may include a BIOS program, an anti-virus program, or a backup/recovery program. The language includes a multi-byte character language, which includes a Unicode character. The language can be each language in the world. The predetermined data includes a compressed data. The predetermined data may be recorded the status for each pixel of characters of the language. The storage apparatus is a ROM. The language can be switched by the user, selected through the user interface by the user or decided by a program stored in the BIOS or the BIOS determining a language version of an Operating System (OS) of the computer system. The language can be selected automatically by the BIOS in accordance with a language version of an Operating System (OS) in an active partition of a hard disk drive (HDD) of the computer system. The language can be decided by an Operating System (OS) of the computer system detecting a language version of the BIOS. The language can be selected by an Operating System (OS) of the computer system in accordance with a program stored in the BIOS.

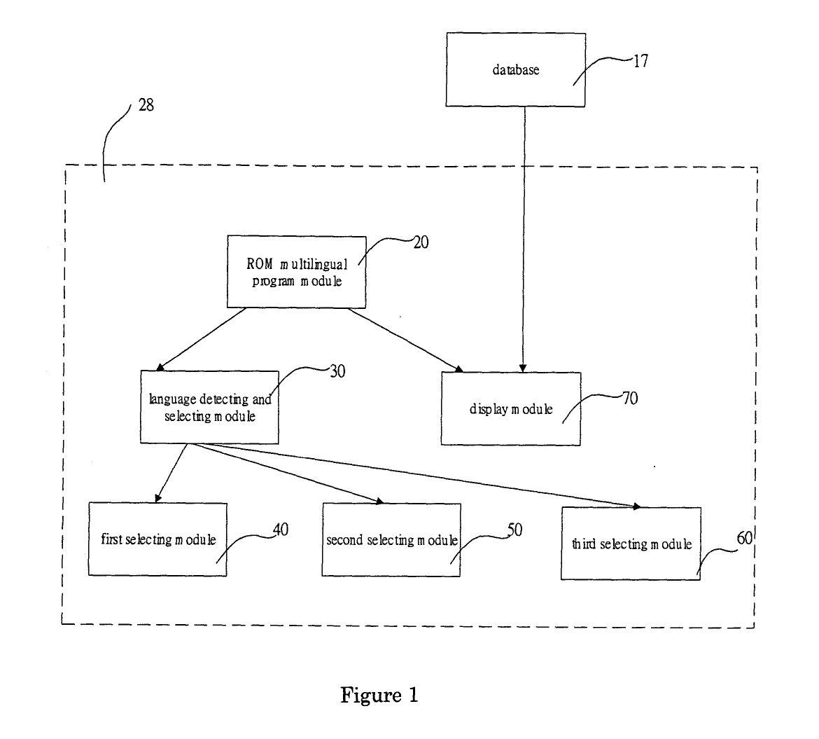

Referring to FIG. 1, a schematic block diagram of a multilingual system of a preferred embodiment according to the present invention is shown. The multilingual system of the present invention is suitable for a computer system to support multi-language for a ROM program.

The computer system has at least a BIOS, an OS and the user interface configured therein. The BIOS processes functions of the computer system. The OS controls the computer system. The user interface provides options for a user to operate, in order to display the language needed by the user.

The multilingual system comprises a database 17 and a storage apparatus 28. The database 17 can be stored in the storage apparatus 28 to preserve a predetermined data corresponded to one or more of a plurality of languages being displayed on the user interface.

The ROM program includes a program burned onto a ROM. The ROM programs may include a BIOS program, an anti-virus program, a backup/recovery program or any other application programs stored in the ROM.

The storage apparatus 28 includes a ROM multilingual program module 20, a language detecting and selecting module 30, a first selecting module 40, a second selecting module 50, a third selecting module 60 and a display module 70, so as to support the ROM program for displaying multi-language on the user interface.

The multi-language displayed on the user interface includes a multi-byte character language, which includes a Unicode character. The language can be each language in the world and can be switched by the user. The language includes Asian language, such as Chinese, Japanese, Korean, and so on. The language also includes Western language, such as English, Germany, Italian, French, Spanish, and so on.

The present invention supports multi-language in the ROM, which converts the simplified Chinese character font data, traditional Chinese character font data, Japanese font data, and other non-ASCII languages into a predetermined data. The predetermined data can be a dot-matrix character font data with multiple languages, in order to display multi-language on the UI.

The dot-matrix character font data records the status for each pixel of characters of the necessary language. If the pixel is going to display, the corresponding data is “1”. Otherwise, the corresponding data is “0”. The predetermined data used to display the ROM programs can be stored in the database 17.

The languages corresponded to the predetermined data may include various language versions to display. The predetermined data can be selected from any language in the world, such as English, Chinese, Japanese, Germany, Italian, French, Spanish, Korean and so on. The dot-matrix character font data is constituted by needed parts of the dot-matrix character font data selected from the font data for various languages, in order to reconstitute a newly dot-matrix character font data with multiple languages. Further, the database 17 is stored in the storage apparatus 28.

The storage apparatus 28 can be a read only memory (ROM). The data burned onto the ROM may include a compressed data. The compressed data contains programs and data needed by such programs to support the ROM programs for multi-language and essential data.

The ROM multilingual program module 20 includes the programs stored in the ROM, the programs burned onto the ROM, which can be a BIOS program, an anti-virus program, a backup/recovery program or any other application programs kept in the ROM.

The language detecting and selecting module 30 is coupled to the ROM multilingual program module 20. The language detecting and selecting module 30 can execute the language detection and selection to detect and select the language version among multiple languages to display on the user interface.

The first selecting module 40 is coupled to the language detecting and selecting module 30, so that the ROM program can select the language to display by way of determining the language version of the Operating System (OS) within the computer system.

The ROM program can search the language version used by the OS from the registry or the archives of the OS, so as to display the interface in such language version. Therefore, supporting multiple languages in the ROM can be achieved.

In case of the first selecting module 40 has failed to search the language version of the OS, then the language version to display is selected in other ways. For example, the selection is made manually by the user through the UI to provide the ROM program with multilingual support.

The second selecting module 50 is coupled to the language detecting and selecting module 30, so that the ROM program can select the language to display by reading out the language version of the BIOS stored in the ROM according to the system ID predetermined when the ROM is burned.

The system ID is a language version identification for the ROM programs to automatically identify the language version of the computer system. The language version identification is determined by the manufacturer before the ROM is burned. To select the language version is first searching from the system ID by the second selecting module 50. At this time, the first selecting module 40 does not detect the language version of the OS.

In case of the second selecting module 50 has failed to search the language version to display on the UI, then the language version is selected from the OS by the first selecting module 40. If the failure still exists, then the selection is finally provided for the user manually through the UI.

The third selecting module 60 is coupled to the language detecting and selecting module 30, which can provide the user to select manually. According to the user's choice, the user can manually select the language version to confirm the corresponding language to instantly switch the language used on the UI.

Moreover, the language version can be determined automatically by the ROM programs according to the language version of the OS within the active partition on the hard disk drive of the computer system. Furthermore, the language version can be determined by the OS detecting the language version of the ROM programs. Besides, the language to display can be selected by the OS according to the programs stored in the ROM programs.

The display module 70 is coupled to the ROM multilingual program module 20, which can display the selected language version on the UI, in order to provide the programs burned onto the ROM with multilingual support to facilitate the user executing the application programs.

The present invention for multilingual support in the ROM is to keep the necessary dot-matrix character font data with multiple languages in the ROM. According to the statistics, the amount of Chinese characters used in the ROM programs does not exceed 200 in general, so that the storage space occupied by the necessary font data is 6 kb merely for displaying the 200 Chinese characters supported the UI.

According to the preferred embodiment of the present invention, a multilingual method for displaying multilingual data on a user interface is suitable for a computer system. The computer system has a detecting apparatus and the user interface configured therein. The detecting apparatus includes a BIOS and an operating system (OS). The BIOS processes functions of the computer system. The operating system (OS) controls the computer system. The user interface provides options for a user. The method comprises the steps of: deciding a first data that can be displayed on the user interface for the user; and storing a second data in a storage apparatus to hold the second data corresponded to the first data therein, the second data can be retrieved by the computer system, in order to display the first data on the user interface for supporting a ROM program.

The multilingual method further comprises the step of performing a predetermined process to convert the first data into a second data. The ROM program includes a program burned onto a read only memory (ROM). The ROM program may include a BIOS program, an anti-virus program, or a backup/recovery program. The language includes a multi-byte character language, which includes a Unicode character. The language can be each language in the world. The second data includes a compressed data. The second data may be recorded the status for each pixel of characters of the language. The storage apparatus is a read only memory (ROM). The language can be switched by the user, selected through the user interface by the user or decided by a program stored in the BIOS or the BIOS determining a language version of an Operating System (OS) of the computer system. The language can be selected automatically by the BIOS in accordance with a language version of an Operating System (OS) in an active partition of a hard disk drive (HDD) of the computer system. The language can be decided by an Operating System (OS) of the computer system detecting a language version of the BIOS. The language can be selected by an Operating System (OS) of the computer system in accordance with a program stored in the BIOS.

Before the ROM programs with multilingual support and essential data needed for such programs are burned onto the storage apparatus 28, the manufacturer designates the system ID. The data for displaying on the UI is decided from the whole font data of the simplified Chinese character, traditional Chinese character, Japanese letters, and other non-ASCII languages, so as to display multilingual data on the user interface for the user.

The data for displaying on the UI is performed a predetermined process to convert into a corresponding data. The corresponding data reconstitute dot-matrix character font data with multiple languages, which records the status for each pixel of characters of the language. The corresponding data, which can be read by the computer system, is stored in the database 17. The database 17 is stored in the storage apparatus 28 that can be a ROM. The data burned onto the ROM may include a compressed data. The compressed data contains programs and data needed by such programs to support the ROM programs for multi-language and essential data. The compression ratio can be 50% to save the storage space in the ROM up to a half.

According to the preferred embodiment of the present invention, a multilingual method for displaying multilingual data on a user interface is suitable for a computer system. The computer system has a detecting apparatus and the user interface configured therein. The detecting apparatus includes a BIOS and an operating system (OS). The BIOS processes functions of the computer system. The operating system (OS) controls the computer system. The user interface provides options for a user. The method comprises the steps of: detecting the computer system to determine a language used in the computer system; retrieving a first data of the determined language kept in the computer system to display the determined language on the user interface in accordance with the determined language used in the computer system; and displaying a second data corresponded to the first data on the user interface to support a ROM program.

The BIOS determines a language version of the OS when the OS is searched and initialized after power-ON for the computer system. The ROM program includes a program burned onto a read only memory (ROM). The ROM program may include a BIOS program, an anti-virus program, or a backup/recovery program. The language includes a multi-byte character language, which includes a Unicode character. The language can be each language in the world. The predetermined data includes a compressed data. The predetermined data may be recorded the status for each pixel of characters of the language. The storage apparatus is a read only memory (ROM). The language can be switched by the user, selected through the user interface by the user or decided by a program stored in the BIOS or the BIOS determining a language version of an Operating System (OS) of the computer system. The language can be selected automatically by the BIOS in accordance with a language version of an Operating System (OS) in an active partition of a hard disk drive (HDD) of the computer system. The language can be decided by an Operating System (OS) of the computer system detecting a language version of the BIOS. The language can be selected by an Operating System (OS) of the computer system in accordance with a program stored in the BIOS. The language can be decided by the Operating System (OS) of the computer system detecting a language version of the BIOS. The method further comprises the step of selecting the language automatically by the BIOS in accordance with a language version of the Operating System (OS) in an active partition of a hard disk drive (HDD) of the computer system. The method further comprises the step of selecting the language by the Operating System (OS) of the computer system in accordance with a program stored in the BIOS.

After the database 17, the ROM multilingual program module 20, the language detecting and selecting module 30, the first selecting module 40, the second selecting module 50, the third selecting module 60 and the display module 70 are burned onto the storage apparatus 28, the ROM program can detect the language version which to display on the UI while the ROM program is executed.

The program burned onto a ROM stored in the ROM multilingual program module 20, such as a BIOS program, an anti-virus program, a backup/recovery program, or any other application program stored in the ROM, can only be readable and can't be modified.

The computer system has at least a detecting apparatus and a user interface configured therein. The detecting apparatus can detect the language version of the computer system, which includes at least a BIOS and an operating system (OS). The BIOS processes functions of the computer system. The operating system (OS) controls the computer system.

The language detecting and selecting module 30 coupled to the ROM multilingual program module 20 is to detect and select the language version to display on the UI among the data contained multiple languages.

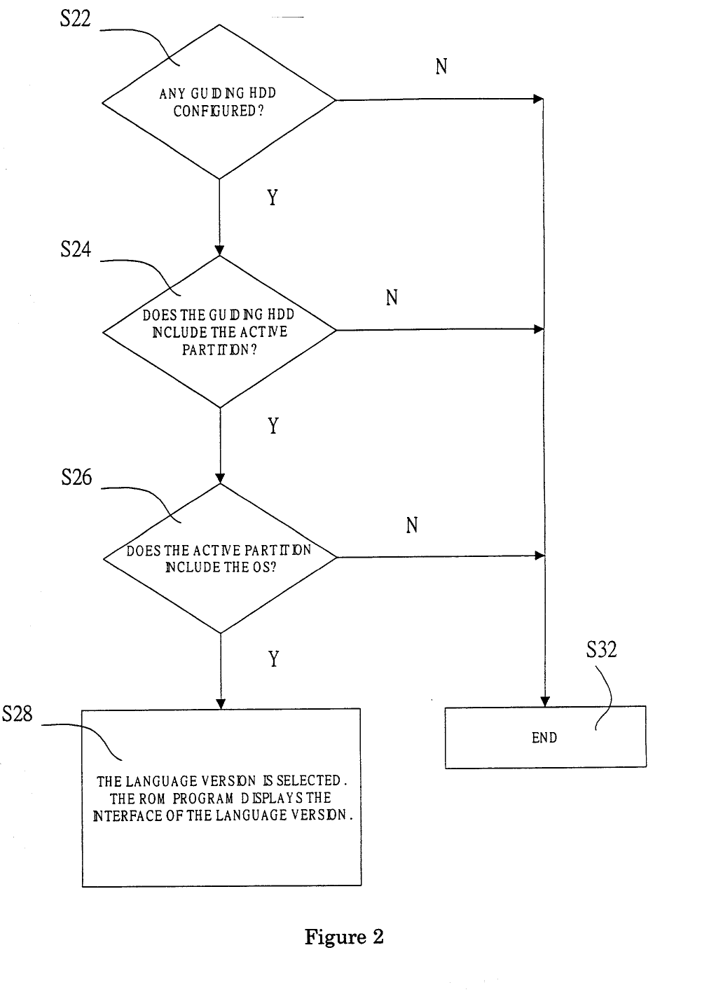

Referring to FIG. 2, a schematic flow chart of a multilingual method of the preferred embodiment according to the present invention is shown. According to the present invention, the first selecting module 40 coupled to the language detecting and selecting module 30 can automatically identify to select the language to display by determining the language version of the OS of the computer system, so that the ROM program can be easily operated.

As shown in FIG. 2, step S22, a first step, is to detect if there is any guiding hard disk drive (HDD) configured in the computer system by the ROM program. If yes, then go to step S24, otherwise go to step S32. At step S24, the ROM program determines whether the guiding hard disk drive (HDD) includes the active partition or not. The active partition is a partition for guiding the OS, such as C: disk. If yes, then go to step S26, otherwise go to step S32.

At step S26, the ROM program searches if the active partition includes the OS. If yes, then go to step S28, otherwise go to step S32.

At step S28, the ROM program searches out the language version used in the OS within the configured archives or the language version is selected from the registry within the OS. Then the ROM program displays the interface of such language version to carry out multilingual support in the ROM.

At step S32, the first selecting module 40 is failed to search out the language version of the OS, and the language version is therefore selected in other ways. For example, the language version is selected manually by the user through the UI to support multiple languages for the ROM programs.

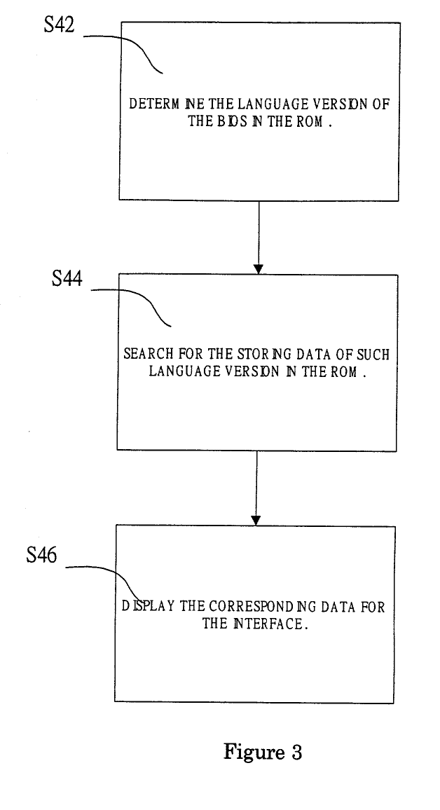

Referring to FIG. 3, another schematic flow chart of a multilingual method of the preferred embodiment according to the present invention is shown. According to the present invention, the second selecting module 50 coupled to the language detecting and selecting module 30 can read out the language version ID within the ROM to select the language to display in accordance with the predetermined system ID when the ROM is burned.

The system ID is to distinguish the language version of the computer system. The system ID is determined by the manufacturer antecedent to the burning process. As shown in FIG. 3, step S42, a first step, is to read out the system ID from the BIOS within the ROM by the ROM program.

Step S44, a second step, is to search out the font data of the selected language version from the dot-matrix character font data with multiple languages in the ROM. The dot-matrix character font data can be predetermined from conventional simplified Chinese character font data, traditional Chinese character font data, Japanese font data, and other non-ASCII language font data.

Step S46, a final step, is to display the selected language data for the interface. The font data of the determined language kept in the computer system is retrieved to display the data corresponded to the font data in the determined language on the user interface to support a ROM program.

The language version of multiple languages is selected first by the second selecting module 50 from the system ID. At this time, the first selecting module 40 doesn't detect the language version of the OS. If the second selecting module 50 is failed to search out the language version for the UI, then the first selecting module 40 determines the language version of the OS. If it does not work either, then the language version is selected manually by the user through the UI.

The third selecting module 60 coupled to the language detecting and selecting module 30 can provide the user to select the language version manually. In accordance with the operation of the user's choice, the language version is confirmed by the user and can be switched by the user instantaneously on the UI.

Furthermore, the language can be selected automatically by the ROM program in accordance with a language version of an Operating System (OS) in the active partition of a hard disk drive (HDD) of the computer system. On the other hand, the language can be decided by an Operating System (OS) of the computer system detecting a language version of the ROM program. The language can be selected by an Operating System (OS) of the computer system in accordance with a program stored in the BIOS also.

After the language version to display for the computer system is decided, the data kept in the computer system for such determined language is retrieved by the ROM program to display the corresponding data in such determined language on the user interface to support a ROM program.

The display module 70 coupled to the language detecting and selecting module 30 can display the selected language version on the UI, so that multilingual support is provided for the programs burned onto the ROM to facilitate the user to perform the application programs.

In the past, if multi-byte character language is displayed for the ROM programs, the huge font data has to be burned onto the ROM. It occupies the ROM space about 240 kb, whereas the ROM space of the computer system is 256 kb merely. For this reason, it is impossible for the prior art to display multiple Asian languages for the programs in the ROM.

Nevertheless, the present invention keeps the font data for multiple languages in the ROM so that the programs in the ROM can support multi-byte characters or multiple multi-byte characters of human languages and the inconvenient use problem of the single English interface faced by the conventional ROM programs can effectively be solved. There's no question about the support of multiple western languages due to such only occupies the storage space totals to 416 bytes.

The multilingual system and method to support multi-byte character languages according to the present invention can bear the 6 kb storage space occupation of the 256 kb storage space of the ROM for displaying the 200 Chinese characters supported the UI. Even though take the support of Japanese and Korean into account, only 18 kb (6 kb for each) storage space is occupied in the ROM. This is also acceptable owing to the need to conveniently perform the application programs being fulfilled.

Furthermore, by using the multilingual technique of the present invention, the font data for Chinese, Japanese and Korean can be compressed to 9 kb storage space with the compression ratio of 50% to save the storage space in the ROM up to a half. Hence, the multilingual system of the present invention not only can provide the support of multiple languages but also can save the storage space in the ROM, as compared to other conventional techniques.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A multilingual system for displaying data on a user interface, which is installed in a computer system having a detecting apparatus and said user interface configured therein, said detecting apparatus including a BIOS and an operating system (OS), said BIOS processing predetermined functions of said computer system, said operating system (OS) controlling operations of said computer system, said user interface providing selectable options for a user, said multilingual system comprising:
a database for holding a predetermined data, said predetermined data corresponding to one or more of a plurality of languages to be displayed on said user interface; and
a storage apparatus for storing said database that supports a ROM program for displaying one of said plurality of languages on said user interface.

2. The multilingual system according to claim 1, wherein said ROM program includes a program burned onto a read only memory (ROM).

3. The multilingual system according to claim 2, wherein said ROM program includes a BIOS program.

4. The multilingual system according to claim 2, wherein said language includes a multi-byte character language.

5. The multilingual system according to claim 1, wherein said predetermined data records the status for each pixel of characters of the displayed language.

6. The multilingual system according to claim 1, wherein said predetermined data includes a compressed data.

7. The multilingual system according to claim 1, wherein said language displayed can be decided by said BIOS that determines a language version of the Operating System (OS) of said computer system.

8. The multilingual system according to claim 1, wherein said language displayed can be decided by the Operating System (OS) that detects a language version of said BIOS.

9. A method for displaying data on a user interface, which is suitable for a computer system having a detecting apparatus and said user interface configured therein, said detecting apparatus including a BIOS and an operating system (OS), said BIOS processing predetermined functions of said computer system, said operating system (OS) controlling operations of said computer system, said user interface providing selectable options for a user, said method comprising the steps of:
detecting said computer system to determine a language in said computer system;
retrieving a first data of said determined language kept in said computer system to display said determined language on said user interface in accordance with said determined language used in said computer system; and
displaying a second data corresponded to said first data on said user interface to support a ROM program.

10. The method according to claim 9, further comprising the step of selecting said language automatically by said BIOS in accordance with a language version of said Operating System (OS) in an active partition of a hard disk driver (HDD) of said computer system, or selecting said language by detecting a language version of said BIOS by said Operating System (OS) of said computer system.

11. The method according to claim 9, further comprising the step of selecting said language by said Operating System (OS) of said computer system in accordance with a program stored in said BIOS.

12. A method for displaying data on a user interface, which is suitable for a computer system having a detecting apparatus and said user interface configured therein, said detecting apparatus including a BIOS and an operating system (OS), said BIOS processing predetermined functions of said computer system, said operating system (OS) controlling operations of said computer system, said user interface providing selectable options for a user, said method comprising the steps of:
deciding a first data for displaying a selected language on said user interface; and
storing a second data in a storage apparatus to hold said second data corresponded to said first data therein, said second data can be retrieved by said computer system, in order to display said first data on said user interface for supporting a ROM program.

13. The method according to claim 12, wherein said language includes a multi-byte character language.

14. The method according to claim 12, wherein said second data records the status for each pixel of characters of said selected language.

15. The method according to claim 12, further comprising the step of performing a predetermined process to convert the first data into a second data.

16. The method according to claim 12, wherein said selected language can be decided by a program stored in said BIOS.

17. The method according to claim 12, wherein said selected language can be decided by said BIOS that determines a language version of said Operating System (OS) of said computer system.

18. The method according to claim 12, wherein said language can be selected automatically by said BIOS in accordance with a language version of said Operating System (OS) in an active partition of a hard disk (HD) of said computer system.

19. The method according to claim 12, wherein said language can be decided by said Operating System (OS) of said computer system that detects a language version of said BIOS.

20. The method according to claim 12, wherein said language can be selected by said Operating System (OS) of said computer system in accordance with a program stored in said BIOS.
